(19) United States
(12) Patent Application Publication
(10) Pub. No.: US 2007/0140948 A1
(43) Pub. Date: Jun. 21, 2007

(54) Peroxides and homogeneous catalysts in petroleum streams

(76) Inventors: Thomas R. Palmer, Baton Rouge, LA (US); William J. Murphy, Baton Rouge, LA (US)

Correspondence Address: ExxonMobil Research & Engineering Company, P.O. Box 900, 1545 Route 22 East, Annandale, NJ, 08801-0900, US

(21) Appl. No.: 11/303,510

(22) Filed: Dec. 16, 2005

(51) Int. Cl. C01B 15/00

(52) U.S. Cl. 423/582; 423/584

(57) ABSTRACT

This invention relates to a method for generating peroxides in petroleum streams. More particularly, peroxides may be generated in-situ by combining the petroleum stream with a high neutralization number (HNN) crude and adding an oxygen-containing stream. HNN crudes contain molecules sufficient for peroxide generation. Peroxides may also be added directly to the petroleum stream without the need for addition of a HNN crude. Oil soluble metal catalysts are added to aid in peroxide formation.

### FIELD OF THE INVENTION

This invention relates to a method for generating peroxides in petroleum streams. More particularly, peroxides may be generated in-situ by combining the petroleum stream with a high neutralization number (HNN) crude and adding an oxygen-containing stream. HNN crudes contain molecules sufficient for peroxide generation. Peroxides may also be added directly to the petroleum stream without the need for addition of a HNN crude. Oil soluble metal catalysts are added to aid in peroxide formation.

### BACKGROUND OF THE INVENTION

Opportunity crudes are crudes that present some difficulties to the refiner and are therefore sold at discount. These crudes may, for example, present corrosion problems because they have high levels of naphthenic acids. Another property of HNN crudes is their elevated levels of large multi-ring naphthene and naphtheno-aromatic molecules. Examples of HNN crudes are Gryphon or Heidrun crude with TAN (total acid number) values of 3.9 and 2.5, respectively. Examples of non-HNN crudes would include Arab Light with a TAN of 0.12 and Olmeca with a TAN of 0.10. However, the supply of such HNN crudes is likely to increase as compared to other low acid crudes. Many strategies have been proposed to deal with acid crudes including corrosion resistant metals, corrosion inhibitors and process modifications.

Almost all crudes contain contaminants that must be removed. The conventional method for removing sulfur (HDS) and nitrogen (HDN) contaminants from lubricant feedstocks in large integrated refineries involves hydrotreating over hydrotreating catalysts. Although hydrotreaters involve an up-front capital expense, hydrotreaters are effective and operational considerations make them a viable economic alternative for removing sulfur and nitrogen contaminants.

Some refineries use solvent refining techniques to produce lubricant basestocks. Solvent refining techniques use solvents to separate a more paraffinic raffinate from a more aromatic extract. As many sulfur and nitrogen contaminants occur in aromatic compounds, they tend to accumulate in the aromatic extract. Solvent refining techniques alone are limited in the economic production of basestocks having a VI greater than about 105. The ever increasing performance standards for modern automobile engines are resulting in demands for basestocks with higher VI. Thus many original equipment manufacturers specify that lubricating oils meet Group II requirements (90+% saturates, <0.03% sulfur, 80-119 VI) and the trend is to even higher basestock qualities of Group III (90+ saturates, <0.03% sulfur and 120+VI). In order to meet Group II standards, solvent extraction has been combined with hydrotreating wherein hydrotreating is used to boost the VI of the raffinate.

Another approach to remove sulfur and nitrogen contaminants is the use of chemical oxidants to convert the sulfur and nitrogen compounds to more polar oxidized species such as sulfoxides, sulfones, nitro compounds, nitroso compounds or amine oxides. The most commonly used oxidant is peroxide based, including for example, inorganic and organic peroxy acids and hydrogen peroxide. The chemical oxidant may be combined with a catalyst to further reduce nitrogen and sulfur contaminants.

Peroxides have also been added to fuels for producing oxygenated components which components impart beneficial properties to the fuels. Peroxides are, however, relatively expensive and may raise operational concerns.

It would be desirable to have an improved oxidation process for decomposing peroxides generated in petroleum streams and to have an outlet for crudes that present corrosion problems.

### SUMMARY OF THE INVENTION

One embodiment of the invention relates to an in-situ method for generating peroxides in crudes or distillates which comprises: (a) combining the crude or distillate with a high neutralization number crude having a total acid number (TAN) greater than 1.0, (b) adding an oil soluble metal catalyst to produce a mixture of crude or distillate, high neutralization crude and oil soluble metal catalyst, and (c) adding an oxygen-containing gas to the mixture from step (b).

Another embodiment relates to a method for generating peroxides in crudes or distillates which comprises: combining the crude or distillate with an oil soluble metal catalyst to produce a mixture of crude or distillate and oil soluble metal catalyst, and (b) adding a peroxide to the mixture.

### BRIEF DESCRIPTION OF THE DRAWINGS

FIG. 1 shows the FTIR subtraction spectra of four sequential samples undergoing oxidation across a wavelength ranging from 600 to 2000 cm⁻¹.

FIG. 2 shows FTIR subtraction spectra of four sequential samples undergoing oxidation reactions generally associated with the region where oxidation products are measured.

### DETAILED DESCRIPTION OF THE INVENTION

Crude oils and distillate fractions that are considered corrosive generally contain organic acids. The organic acids most commonly associated with acidic properties are naphthenic acids. The acidity of a crude or distillate is normally measured as the Total Acid Number or TAN. The TAN is measured by standard ASTM methods such as D-664 and is expressed as the number of milligrams of KOH need to neutralize one gram of oil. Crudes and distillates with TAN values below 0.5 are considered non-corrosive, those with TAN values between 0.5 and 1.0 are considered moderately corrosive and those with TAN values above 1.0 are considered corrosive. These corrosive crudes are known as High Neutralization Number crudes or “HNN” crudes.

Suitable feeds for mixing with HNN crudes include crudes having a TAN less than 1.0, reduced crudes, raffinates, hydrotreated oils, hydrocrackates, atmospheric gas oils, vacuum gas oils, coker gas oils, atmospheric and vacuum resids, deasphalted oils, slack waxes and Fischer-Tropsch wax. Such feeds may be derived from distillation towers (atmospheric and vacuum), hydrotreaters and solvent extraction units, and may have wax contents of up to 50% or more.

HNN crudes and distillates derived therefrom are not typically used for the production of lubricant basestocks because of their inherent instability to oxidation. These crudes contain multi-ring naphthenes and naphtheno-aromatic compounds that are easily oxidized because they have exposed tertiary hydrogens that are readily susceptible to oxidation. It is this oxidation instability which has been used to advantage in the instant process.

In the present process, the multi-ring naphthenes and naphtheno-aromatic compounds in HNN crudes and distillates are oxidized by exposing these compounds to an oxidizing medium to form in-situ generated hydroperoxides. An example of such a reaction is as follows:

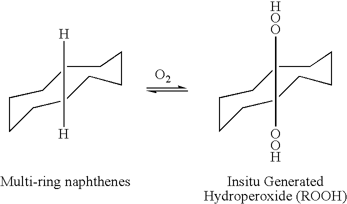

Naphthenes are cycloparaffins having one or more cyclic rings. The rings may have 5 or more carbon atoms and may be substituted with substituents such as alkyl groups. Examples of one ring naphthenes include cyclopentane, cyclohexane, cyclooctane, methyl cyclohexane, ethyl cyclohexane, and the like. Naphthenes may also be polycyclic, i.e., containing multiple rings. Heavier petroleum fractions commonly include polycyclic naphthenes containing 2, 3, 4, 5 or more cyclic rings which may be fused. The cyclic rings may contain 5 or more carbon atoms and may bear substituents such as alkyl groups. The polycyclic naphthenes may also be bridged. Naphtheno-aromatics are fused polycyclic hydrocarbons containing both aromatic and naphthene ring systems. The fused ring systems may contain 2 or more rings and the rings may contain 5 or more carbon atoms. Preferred naphthens and naphtheno-aromatics contain 2 or more rings which may be substituted with alkyl. Examples include decalin, adamantane, cholestane, tetralin, norborane, 3-methyl-1,2-cyclopentenophenanthrene, 1,2,3,4-tetrahydrophenanthrene, indane, perhydroanthracene, perhydrofluorene and perhydroterphenyl,

In one embodiment, the amount of HNN crudes that are mixed with other crudes, distillates or mixtures thereof range from 10 to 100 wt. %, based on total mixture of HNN crude and other crude or distillate, preferably 30 to 100 wt. %. The mixing of HNN crudes with other petroleum crudes and distillates occurs at temperatures greater than about 50° C.

The oxidizing medium for embodiments containing HNN crude mixtures may be an oxygen-containing gas, preferably oxygen, and most preferably air. Ozone may also be used as an oxidizing medium. The oxidizing medium may be mixed with other non-oxidizing gases or may be mixed with inert solvent. In order to form in-situ hydroperoxides, an oxygen-containing gas is added to the mixture by any conventional means for mixing gases and liquids. Oxygen-containing gas is added for a time sufficient to generate peroxides in a concentration of at least about 1 wt. %, based on mixture.

In another embodiment, oil soluble catalysts may be added to the HNN mixture. Oil soluble metal catalysts include metals from Groups 4-12 of the Periodic Table based on the IUPAC format having Groups 1-18. Examples of metals include V, Cr, Mo, W, Fe, Ni, Co Pt, Pd, Ru and Mn. The oil soluble metal catalysts include salts and compounds such as organic acids such as acyclic, alicyclic and aromatic carboxylates including carboxylates, sulfonates, naphthenates, chelates such as acetylacetonates, halides, sulfonates, organic amines, hetropolyacids and the like that render the metal oil soluble. Preferred oil soluble metal catalysts include metal naphthenates, metal acetates and metal beta diketonates. The oil soluble metal catalyst may also be combined with inert solvents, especially non-polar solvents such as hydrocarbons, e.g., mineral oils, turbine oils, naphthenic oils, paraffinic oils, synthetic oils and the like. The metal concentrations are from 1 to 1000 wppm, based on crude or distillate plus HNN crude. The preferred reaction temperatures are from 50-250° C., most preferably from 100-160° C.

In another embodiment not involving the addition of HNN crudes, peroxides may be combined with crude and/or distillate containing oil soluble metal catalyst. In this embodiment, the peroxide may be added directly to the mixture of crude/distillate and oil soluble metal catalyst. Suitable peroxides include hydrogen peroxide, inorganic peroxide compounds, salts of peracids such as perborates, and organic peroxides such as benzoyl peroxide.

The formation of hydroperoxides may be monitored by following the decomposition products from peroxide formation. For example, naphthenes may generate carbonyl containing compounds upon decomposition of the intermediate peroxide species. Carbonyl compound formation may be monitored by Fourier Transform Infrared spectroscopy using well known techniques. Alternatively, peroxide formation may directly monitored using methods known in the art. Methods for detecting peroxides include electroanalytical methods, spectroscopic methods, chemical methods or some combination thereof. An example of electroanalytical methods would be the use of electrodes for detecting peroxide formation. Spectroscopic methods include UV spectroscopy and calorimetric methods. Chemical methods are frequently coupled with spectroscopic methods. For example, peroxides are known to react compounds in a reaction that produces chemiluminescence. Other examples include compounds that reaction peroxides to produce fluorescence. The luminescence may be detected spectroscopically. For a review of methods for peroxide formation, reference is made to U.S. Pat. No. 6,919,463.

The oxygen-containing gas may be added by conventional means such as frits, spargers, bubblers and the like, or may be added under pressure to a vessel containing the HNN mixture and allowed to diffuse into HNN mixture. The conditions for adding oxygen-containing gas include temperatures from ambient to 700° C., pressures from atmospheric to 34576 kPa (5000 psig), and treat gas rates up to 534 m³/m³ (3000 scf/B). The oxygen-containing gas is added to the mixture for a time sufficient to generate peroxides in a concentration of at least about 1 wt. %, based on mixture.

The in-situ generated peroxides may then be reacted in the same way as conventionally added peroxides such as hydrogen peroxide. For example, in-situ generated peroxides involving polar species may the used to separate or destroy the polar species. U.S. Pat. No. 5,310,479 discloses that the sulfur content of whole crudes may be reduced by treating the crude with hydrogen peroxide and formic acid followed by water washing to remove water soluble oxidized sulfur compounds. In-situ generated peroxides have a cost advantage since no expensive peroxides need be purchased. Moreover, the need to handle peroxides external to the reaction mixture is avoided.

In the case of peroxide addition not involving a HNN crude, the oil soluble metal catalyst, peroxide and lube feedstock may be mixed together with stirring for a period sufficient for peroxide oxidation to be complete. The precise order of mixing peroxide, oil soluble metal catalyst and feed is not critical.

This invention is further illustrated by the following example.

### EXAMPLE

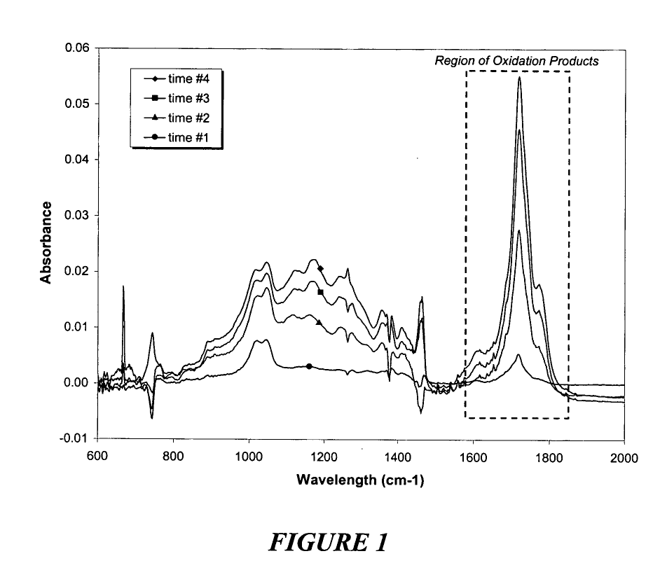

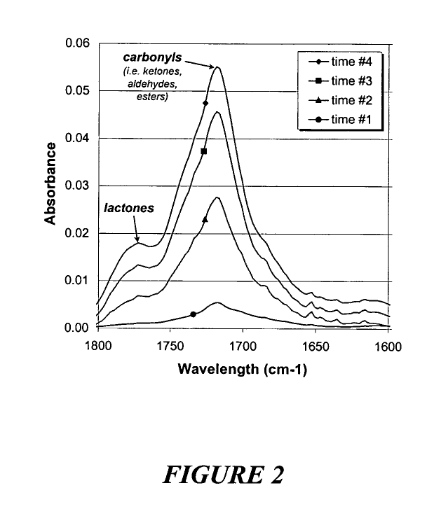

Experiments were conducted using a dewaxed HNN distillate as a test fluid and heated to 150° C. in the presence of air bubbling through the fluid. The oxidation products were measured by Fourier Transform Inferred Spectroscopy (FTIR) to determine the existence of oxidation products. Additionally a sample was heated in the presence of a nitrogen gas instead of air to determine the effect of any thermal degradation of the fluid under these test conditions. This sample was also measured by FTIR and used as a baseline reading. A subtraction spectra was generated at four different times during the oxidation experiments using the FTIR readings minus the baseline reading. The results are given in FIGS. 1 and 2, where FIG. 1 shows the FTIR subtraction spectra of four sequential samples undergoing oxidation across a wavelength ranging from 600 to 2000 cm⁻¹. FIG. 2 shows FTIR subtraction spectra of four sequential samples undergoing oxidation reactions generally associated with the region where oxidation products are measured. The Figure shows a close-up of products FTIR subtraction spectra for the region of interest to determine oxidation products of four sequential samples undergoing oxidation reactions.

When examining the spectra generated from these samples, it is evident that there was an increase in the amount of oxidation products generated as the oxidation reaction proceeded, shown by the increase in the area under the peaks in the 1600-1800 cm⁻¹ region. Specifically, there are noticeable peaks present at 1773 representing carbonyls such as ketones, aldehydes, and esters, along with a peak at 1718 cm⁻ representing the presence of lactone carbonyls. This data provides proof that oxidation reactions occurred during the experiments. In order for the oxidation pathways necessary for these reactions to occur, an intermediate step must have existed in which peroxides or hydroperoxides were generated. An example of a reaction mechanism is provided below showing the pathway from a hydrocarbon to a ketone carbonyl.

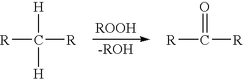

1. An in-situ method for generating peroxides in crudes or distillates which comprises: (a) combining the crude or distillate with a high neutralization number crude having a total acid number (TAN) greater than 1.0, (b) adding an oil soluble metal catalyst to produce a mixture of crude or distillate, high neutralization crude and oil soluble metal catalyst, and (c) adding an oxygen-containing gas to the mixture from step (b) for a time sufficient to generate peroxides in a concentration of at least about 1 wt. %, based on mixture.

2. A method for generating peroxides in crudes or distillates which comprises: combining the crude or distillate with an oil soluble metal catalyst to produce a mixture of crude or distillate and oil soluble metal catalyst, and (b) adding a peroxide to the mixture.

3. The process of claims 1 or 2 wherein the high neutralization number crude contains multi-ring naphthenes and naphtheno-aromatic compounds.

4. The process of claims 1 or 2 wherein the multi-ring naphthenes and naphtheno-aromatic compounds react with oxygen-containing gas to form peroxides.

5. The process of claim 1 wherein the amount of HNN crudes that are mixed with other crudes, distillates or mixtures thereof range from 10 to 100 wt. %, based on total mixture of HNN crude and other crude or distillate.

6. The process of claim 1 wherein the oxygen-containing gas is air.

7. The process of claim 1 wherein the oxygen-containing gas is added to mixture of crude or distillate and high neutralization crude at temperatures from ambient to 700° C., pressures from atmospheric to 34576 kPa (5000 psig), and treat gas rates up to 534 m³/m³ (3000 scf/B).

8. The process of claims 1 or 2 wherein the oil soluble metal catalyst includes metals from Groups 4-12.

9. The process of claim 8 wherein the metal include at least one of V, Cr, Mo, W, Fe, Ni, Co, Pt, Pd, Ru and Mn.

10. The process of claim 2 wherein the peroxide is at least one of hydrogen peroxide, inorganic peroxide or organic peroxide.
